(19) United States
(12) Patent Application Publication
(10) Pub. No.: US 2021/0194736 A1
(43) Pub. Date: Jun. 24, 2021

(54) METHOD AND DEVICE FOR LONG TERM BEAMFORMING

(71) Applicant: Nokia Solutions and Networks Oy, Espoo (FI)

(72) Inventor: Stefan Wesemann, Kornwestheim (DE)

(21) Appl. No.: 17/048,327

(22) PCT Filed: Apr. 16, 2018
(86) PCT No.: PCT/EP2018/059685

§ 371 Date: Oct. 16, 2020

(51) Int. Cl. H04L 25/02; H04B 7/06; H04L 5/00

(52) U.S. Cl. CPC H04L 25/0226; H04B 7/0634; H04B 7/0626; H04L 5/0051; H04L 25/0242; H04B 7/0617

(57) ABSTRACT

A method and device, the method comprising receiving (S1) sounding reference signal (SRS) information or demodulation reference signal (DMRS) information, determining (S2) a channel estimate of a channel for a set of users depending on the information, determining (S3) an active user subset ({1, . . . , K}) of the set of users depending on the information, determining (S4) weights (W(i)) for long term beamforming depending on the channel estimate and on the active user subset ({1, . . . , K}).

### TECHNICAL FIELD

Various examples relate to a method and device for long term beamforming.

### BACKGROUND

In massive MIMO systems beamforming weights are used for long term beamforming by a remote radio unit, RRU. The remote radio unit receives these beamforming weights from a scheduler of a baseband unit (BBU).

### SUMMARY

Example embodiments relate to a method comprising receiving sounding reference signal information or demodulation reference signal information, determining a channel estimate of a channel for a set of users depending on the information, determining an active user subset of the set of users depending on the information, determining weights for long term beamforming depending on the channel estimate and on the active user subset.

The method may comprise determining a channel vector estimate for a user at a time instance for a sub-band of the channel.

The method may comprise determining the subset of active users by either comparing a time a user is in the active user subset without performing a sounding reference signal or demodulation reference signal transmission to a maximum time period, or by limiting a number of users in the active user subset to a maximum number of users.

The method may comprise comparing the time a user is in the active user subset without performing a sounding reference signal or demodulation reference signal transmission to a threshold to determine that the maximum time period is exceeded, and/or limiting the number of users in the active user subset to the maximum number of users by first in first out memory of finite or configurable size.

The method may comprise receiving for sub-bands of a plurality of sub-bands a channel estimate for a user, and the subset of active users, and determining per sub-band for the user the recursions

βₖ⁻¹(i)=(1−α)βₖ⁻¹(i−1)+α∥hₖ(i)∥²

R̅ₖ(i)=(1−α)R̅ₖ(i−1)+αhₖ(i)h_{k,[1:P]}^{H}(i)
wherein
i denotes time instance,
k denotes a user,
hₖ(i) denotes a channel vector at the time instance,
R̅ₖ(i) denotes an estimated (partial) covariance matrix at the time instance,
α denotes a forgetting factor for the time averaging, in particular 0.01, wherein
βₖ⁻¹(0) and R̅ₖ(0) are initialized with zeros of appropriate size,
[1:P] is a subscript for selecting the first P elements from a vector.

The method may comprise receiving a message, which consists of a user index and a sub-band index of a sub-band of the plurality of sub-bands, configuring or triggering the active user selection means to add a particular user to the active user subset. This allows configuring the reception in uplink in advance where no SRS/DMRS is performed.

The method may comprise determining multiple channel vectors for sub-bands f in {1, . . . F} for a user, wherein

$${β}_{k}^{- 1} ( i ) = ( 1 - α ) {β}_{k}^{- 1} ( i - 1 ) + α {\sum }_{f = 1}^{F} {‖ {h}_{k} ( i , f ) ‖}^{2}$$

$${\overline{R}}_{k} ( i ) = ( 1 - α ) {\overline{R}}_{k} ( i - 1 ) + α {\sum }_{f = 1}^{F} {h}_{k} ( i , f ) {h}_{k , [ 1 \text{:} P ]}^{H} ( i , f )$$

The method may comprise determining a weighted sum over users in the active user subset {1, . . . , K} by

$$\overline{R} ( i ) = {\sum }_{k = 1}^{K} {β}_{k}^{- 1} ( i ) {\overline{R}}_{k} ( i )$$

The method may comprise determining the weighted sum over all users in the active user subset.

The method may comprise determining the weights W(i) by a Gram-Schmidt orthonormalization of the estimated covariance matrix.

The method may comprise determining the weights W(i) as

$$W ( i ) = arg {max}_{W ∈ 𝒲} {‖ x ‖}^{2} = {V}_{[ \text{:} , 1 \text{:} P ]} with$$

$$V Λ {V}^{H} = {\sum }_{k = 1}^{K} {β}_{k}^{- 1} ( i ) {R}_{k} ( i )$$

wherein
x denotes the received signal, and

βₖ(i)=tr(Rₖ(i)).

Example embodiments relate to a device, that comprises a channel estimation means configured to receive sounding reference signal information or demodulation reference signal information, and to determine a channel estimate of a channel for a set of users depending on the information, an active user selection means, configured to receive the sounding reference signal information or the demodulation reference signal information, and to determine an active user subset of the set of users depending on the information, an adaptive grid-of-beams means, configured to determine weights for long term beamforming depending on the channel estimate and on the active user subset.

The channel estimation means may be configured to determine a channel vector estimate for a user at a time instance for a sub-band of the channel.

The active user selection means may be configured to determine the subset of active users by either comparing a time a user is in the active user subset without performing a sounding reference signal or demodulation reference signal transmission to a maximum time period, or by limiting a number of users in the active user subset to a maximum number of users.

The time a user is in the active user subset without performing a sounding reference signal or demodulation reference signal transmission may be compared to a threshold to determine that the maximum time period is exceeded, and/or wherein the number of users in the active user subset may be limited to the maximum number of users by first in first out memory of finite or configurable size.

The adaptive grid-of-beams means may be configured to receive for sub-bands of a plurality of sub-bands a channel estimate for a user, and the subset of active users, and to determine per sub-band for the user the recursions

βₖ⁻¹(i)=(1−α)βₖ⁻¹(i−1)+α∥hₖ(i)∥²

R̅ₖ(i)=(1−α)R̅ₖ(i−1)+αhₖ(i)h_{k,[1:P]}^{H}(i)
wherein
i denotes time instance,
k denotes a user,
hₖ(i) denotes a channel vector at the time instance,
R̅ₖ(i) denotes an estimated (partial) covariance matrix at the time instance,
α denotes a forgetting factor for the time averaging, in particular 0.01, wherein
βₖ⁻¹(0) and R̅ₖ(0) are initialized with zeros of appropriate size,
[1:P] is a subscript for selecting the first P elements from a vector.

The active user selection means may be configurable or triggerable to add a particular user to the active user subset, depending on a received message, which consists of a user index and a sub-band index of a sub-band of the plurality of sub-bands. This allows configuring the uplink in advance.

The channel estimation means may be configured to determine multiple channel vectors for sub-bands f in {1, . . . F} for a user, wherein

$${β}_{k}^{- 1} ( i ) = ( 1 - α ) {β}_{k}^{- 1} ( i - 1 ) + α {\sum }_{f = 1}^{F} {‖ {h}_{k} ( i , f ) ‖}^{2}$$

$${\overline{R}}_{k} ( i ) = ( 1 - α ) {\overline{R}}_{k} ( i - 1 ) + c 1 {\sum }_{f = 1}^{F} {h}_{k} ( i , j ) {h}_{k , [ 1 : P ]}^{H} ( i , f )$$

The adaptive grid-of-beams means may be configured to determine a weighted sum over users in the active user subset {1, . . . , K} by

$$\overline{R} ( i ) = {\sum }_{k = 1}^{K} {β}_{k}^{- 1} ( i ) {\overline{R}}_{k} ( i )$$

The weighted sum may be determined over all users in the active user subset.

The adaptive grid-of-beams means may be configured to determine the weights W(i) by a Gram-Schmidt orthonormalization of the estimated covariance matrix.

The weights W(i) may be determined as

$$W ( i ) = arg {max}_{W ∈ 𝒲} {‖ x ‖}^{2} = {V}_{[ : , 1 : P ]} with$$

$$V {AV}^{H} = {\sum }_{k = 1}^{K} {β}_{k}^{- 1} ( i ) {R}_{k} ( i )$$

wherein
x denotes the received signal, and

βₖ(i)=tr(Rₖ(i)).

### BRIEF DESCRIPTION OF THE DRAWINGS

FIG. 1 shows an example of a device according to the subject matter described herein,

FIG. 2 shows an example of a method according to the subject matter described herein,

FIG. 3 shows an example of an implementation according to the subject matter described herein.

### DETAILED DESCRIPTION

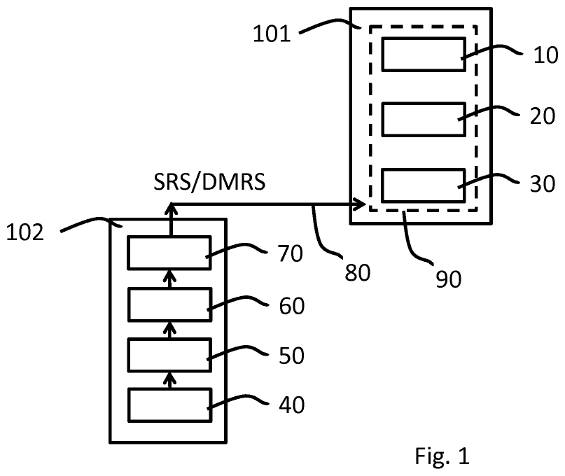

Referencing FIG. 1, a device 101 for long term beamforming is described below using an example of uplink in a remote radio unit RRU. Long term beamforming in downlink may be applied alike. Any reference to uplink, uplink channel or the like refers to a downlink, a downlink channel or more generally to a channel.

FIG. 1 schematically depicts a part of a wireless communication network comprising the RRU and a base band unit, BBU, 102. The RRU controls an antenna not depicted in FIG. 1 for long-term beamforming.

The RRU comprises an uplink channel estimation means 10 configured to receive sounding reference signal SRS information or demodulation reference signal DMRS information.

SRS may be transmitted by a user equipment (UE) for determining the channel state information over a configurable bandwidth. The demodulation reference signal DMRS may provide channel state information for a frequency region in which PUSCH or PUCCH is being transmitted.

The uplink channel estimation means 10 is configured to determine an uplink channel estimate for a set of users depending on this information.

The RRU comprises an active user selection means 20, configured to receive the sounding reference signal SRS information or the demodulation reference signal DMRS information, and to determine an active user subset of the set of users depending on the information,

The RRU comprises an adaptive grid-of-beams means 30, configured to determine weights W(i) for long term beamforming depending on the uplink channel estimate and on the active user subset.

The uplink channel estimation means 10 is configured to determine a channel vector estimate Hₖ(i) for a user k at a time instance i for a sub-band of the uplink channel.

The active user selection means 20 is configured to determine the subset of active users {1, . . . , K} by either comparing a time a user k is in the active user subset {1, . . . , K} without performing a sounding reference signal SRS or demodulation reference signal DMRS transmission to a maximum time period, or by limiting a number of users in the active user subset {1, . . . , K} to a maximum number of users.

The time a user k is in the active user subset {1, . . . , K} without performing a sounding reference signal SRS or demodulation reference signal DMRS transmission is for example compared to a threshold to determine that the maximum time period is exceeded, and/or wherein the number of users in the active user subset {1, . . . , K} is limited to the maximum number of users by first in first out memory of finite or configurable size.

The adaptive grid-of-beams 30 means may be configured to receive an uplink channel estimate UL-CSI for a user k, and the subset of active users {1, . . . , K}, and to determine for the user the recursions

βₖ⁻¹(i)=(1−α)βₖ⁻¹(i−1)+α∥hₖ(i)∥²

R̅ₖ(i)=(1−α)R̅ₖ(i−1)+αhₖ(i)h_{k,[1:P]}^{H}(i)
wherein
i denotes time instance,
k denotes a user,
hₖ(i) denotes a channel vector at the time instance,
R̅ₖ(i) denotes an estimated (partial) covariance matrix at the time instance,
α denotes a forgetting factor for the time averaging, in particular 0.01, wherein
βₖ⁻¹(0) and R̅ₖ(0) are initialized with zeros of appropriate size,
[1:P] is a subscript for selecting the first P elements from a vector.

The uplink channel estimation means 10 may be configured to determine multiple channel vectors for sub-bands f in {1, . . . F} for a user (k), wherein

$${β}_{k}^{- 1} ( i ) = ( 1 - α ) {β}_{k}^{- 1} ( i - 1 ) + α {\sum }_{f = 1}^{F} {‖ {h}_{k} ( i , f ) ‖}^{2}$$

$${\overline{R}}_{k} ( i ) = ( 1 - α ) {\overline{R}}_{k} ( i - 1 ) + c 1 {\sum }_{f = 1}^{F} {h}_{k} ( i , j ) {h}_{k , [ 1 : P ]}^{H} ( i , f )$$

The adaptive grid-of-beams 30 means may be configured to determine a weighted sum over users in the active user subset {1, . . . , K} by

$$\overline{R} ( i ) = {\sum }_{k = 1}^{K} {β}_{k}^{- 1} ( i ) {\overline{R}}_{k} ( i )$$

The weighted sum may be determined over all users in the active user subset {1, . . . , K}.

The adaptive grid-of-beams 30 means may be configured to determine the weights W(i) by a Gram-Schmidt orthonormalization of the estimated covariance matrix.

The adaptive grid-of-beams 30 means may be configured to determine the weights W(i) as

$$W ( i ) = arg {max}_{W ∈ 𝒲} {‖ x ‖}^{2} = {V}_{[ : , 1 : P ]} with$$

$$V {AV}^{H} = {\sum }_{k = 1}^{K} {β}_{k}^{- 1} ( i ) {R}_{k} ( i )$$

wherein
x denotes the received signal, and

βₖ(i)=trRₖ(i).

The BBU provides for example in a downlink user plane encoding means 40, modulation means 50, layer mapping means 60 and precoding means 70. A link 80 between the BBU and the RRU is provided as interface between precoding means and beamforming means 90.

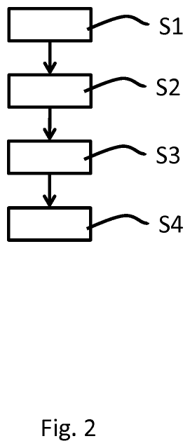

A method exemplary for the subject matter of this application, in particular for determining weights W(i) for long term beamforming at the RRU, is described below referencing FIG. 2. The method may be applied per sub-band of a plurality of sub-bands. In particular the method may be applied in parallel to various sub-bands separately.

The method comprises a step S1 of receiving, at the RRU, sounding reference signal SRS information or demodulation reference signal DMRS information.

The method comprises a step S2 of determining, at the RRU, the uplink channel estimate for the set of users depending on the information.

The method comprises a step S3 of determining, at the RRU, the active user subset of the set of users depending on the information.

The method comprises a step S4 of determining, at the RRU, weights W(i) for long term beamforming depending on the uplink channel estimate and on the active user subset.

The RRU can use the weights for long-term beamforming according to the downlink system model at a time instance i

x(i)=H^{H}WPd(i)+z(i)

where

x denotes the received signal, and

H denotes the uplink channel matrix H=[h₁, . . . , hᵢ],

P denotes the number of ports,

d denotes user data,

z denotes additive perturbations.

The method may comprise determining a channel vector estimate Hₖ(i) for a user k at a time instance i) for a sub-band of the uplink channel.

The method may comprise determining the subset of active users {1, . . . , K} by either comparing a time a user k is in the active user subset {1, . . . , K} without performing a sounding reference signal SRS or demodulation reference signal DMRS transmission to a maximum time period, or by limiting a number of users in the active user subset {1, . . . , K} to a maximum number of users.

The method may comprise comparing the time a user k is in the active user subset {1, . . . , K} without performing a sounding reference signal SRS or demodulation reference signal DMRS transmission to a threshold to determine that the maximum time period is exceeded, and/or limiting the number of users in the active user subset {1, . . . , K} to the maximum number of users by first in first out memory of finite or configurable size.

The method may comprise receiving an uplink channel estimate UL-CSI for a user k, and the subset of active users {1, . . . , K}, and determining for the user k the recursions

βₖ⁻¹(i)=(1−α)βₖ⁻¹(i−1)+α∥hₖ(i)∥²

R̅ₖ(i)=(1−α)R̅ₖ(i−1)+αhₖ(i)h_{k,[1:P]}^{H}(i)
wherein
i denotes time instance,
k denotes a user,
hₖ(i) denotes a channel vector at the time instance,
R̅ₖ(i) denotes an estimated covariance matrix at the time instance,
α denotes a forgetting factor for the time averaging, in particular 0.01, wherein
βₖ⁻¹(0) and R̅ₖ(0) are initialized with zeros of appropriate size,
[1:P] is a subscript for selecting the first P elements from a vector.

The method may comprise determining multiple channel vectors for sub-bands f in {1, . . . F} for a user k, wherein

$${β}_{k}^{- 1} ( i ) = ( 1 - α ) {β}_{k}^{- 1} ( i - 1 ) + α {\sum }_{f = 1}^{F} {‖ {h}_{k} ( i , f ) ‖}^{2}$$

$${\overline{R}}_{k} ( i ) = ( 1 - α ) {\overline{R}}_{k} ( i - 1 ) + c 1 {\sum }_{f = 1}^{F} {h}_{k} ( i , j ) {h}_{k , [ 1 : P ]}^{H} ( i , f )$$

The method may comprise determining a weighted sum over users in the active user subset {1, . . . , K} by

$$\overline{R} ( i ) = {\sum }_{k = 1}^{K} {β}_{k}^{- 1} ( i ) {\overline{R}}_{k} ( i )$$

The method may comprise determining the weighted sum over all users in the active user subset {1, . . . , K}.

The method may comprise determining the weights W(i) by a Gram-Schmidt orthonormalization of the estimated covariance matrix.

The method may comprise determining the weights W(i) as

$$W ( i ) = arg {max}_{W ∈ 𝒲} {‖ x ‖}^{2} = {V}_{[ : , 1 : P ]} with$$

$$V {AV}^{H} = {\sum }_{k = 1}^{K} {β}_{k}^{- 1} ( i ) {R}_{k} ( i )$$

wherein
x denotes the received signal, and

βₖ(i)=trRₖ(i).

In the example the RRU requires only the SRS or DMRS information to determine the long-term weights independent from the BBU. The application of the weights is independent of the BBU as well.

Additionally, a message may be used, which consists of a user index and a sub-band index of a sub-band of the above mentioned plurality of sub-bands. The message may be sent from the BBU to RRU to configure or trigger the active user selection means 303 to add a particular user k to the active user subset {1, . . . , K}. This is useful for reception in the uplink, where no SRS/DMRS is performed in advance. With this additional message from the BBU, the RRU can adjust the long-term beamforming weights for users in the uplink before the actual uplink transmission takes place.

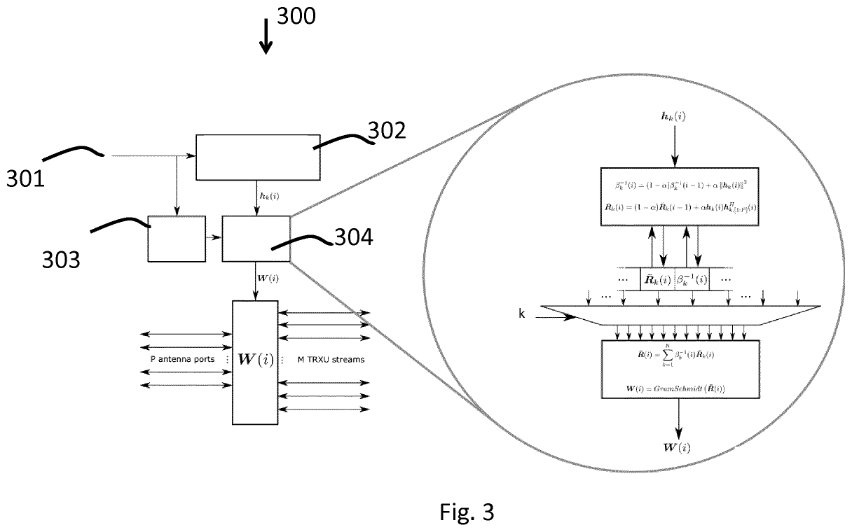

The structure of the proposed (recursive) method is depicted in FIG. 3.

A device 300 according to this example comprises a common public radio interface, CPRI, 301 for receiving SRS/DMRS information for a current transmission time interval, TTI. The TTI is referred to as time instance. In particular, the CPRI is a time domain CPRI suitable to connect to a BBU that does not support a L1-High/L1-Low split according to the evolving enhanced Common Public Radio Interface eCPRI standard version 1.0 and beyond, in which short-term precoding/decoding is implemented in the L1-High and long-term beamforming is implemented in the L1-Low.

The CPRI may be implemented for example according to the specifications CPRI 7.0 or an earlier version.

The CPRI 301 provides the SRS/DMRS information at a time instance i to an uplink channel estimation means 302 of the device 300.

The uplink channel estimation means 302 is configured to determine a channel vector at the time instance i

h_k(i)

depending on this information.

The CPRI 301 provides the SRS/DMRS information at the time instance i to an active user selection means 303 of the device 300. The active user selection means 303 is configured determine an active user subset {1, . . . , K} of the set of users {1, . . . , K} depending on this information.

An adaptive grid-of-beams means 304 of the device 300 is configured to receive the channel vector h_k(i) at the time instance i and the active user subset {1, . . . , K}. The adaptive grid-of beams means 304 is configured to determine weights W(i) for long term beamforming depending on the uplink channel estimate h_k(i) and on the active user subset {1, . . . , K}. The adaptive grid-of beams means 304 is for example configured to determine weights W(i) according to the method described above. This is schematically depicted in FIG. 3 as a zoomed view on the right side of the adaptive grid-of beams means 304.

Accordingly, in the example it is distinguished between tasks that are done per user k and the task that forms a set of long-term beamforming weights W(i).

The set of long-term beamforming weights W(i) is applied in beamforming for P antenna ports accordingly.

The means describe above may be implemented as processors with storage, such as microprocessors or microcontrollers or the like. The storage may comprise computer-readable instructions that when executed by the processor, perform steps of the method of described above. Any reference to a processor may refer to a field programmable gate array FPGA, an application specific integrated circuit ASIC, a system on a chip SoC and the like.

The instructions comprise in particular a self-contained long-term beamforming algorithm for a time division duplex, TDD, system utilizing explicit channel state information.

The description and drawings merely illustrate the principles of exemplary embodiments. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of exemplary embodiments and the concepts contributed by the inventor(s) to furthering the art, and are to be construed as being without limitation to such specifically recited examples and conditions. Moreover, all statements herein reciting principles, aspects, and embodiments, as well as specific examples thereof, are intended to encompass equivalents thereof.

It should be appreciated by those skilled in the art that any block diagrams herein represent conceptual views of illustrative circuitry embodying exemplary embodiments. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

A person of skill in the art would readily recognize that steps of various above-described methods can be performed and/or controlled by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1-22. (canceled)

23. A method, comprising:
receiving sounding reference signal (SRS) information or demodulation reference signal (DMRS) information;
determining a channel estimate of a channel for a set of users depending on the information;
determining an active user subset ({1, . . . , K}) of the set of users depending on the information;
determining weights (W(i)) for long term beamforming depending on the channel estimate and on the active user subset ({1, . . . , K}).

24. The method according to claim 23, further comprising
determining a channel vector estimate (Hₖ(i)) for a user (k) at a time instance (i) for a sub-band of the channel.

25. The method according to claim 23, further comprising
determining the subset of active users ({1, . . . , K}) by either comparing a time a user (k) is in the active user subset ({1, . . . , K}) without performing a sounding reference signal (SRS) or demodulation reference signal (DMRS) transmission to a maximum time period, or by limiting a number of users in the active user subset ({1, . . . , K}) to a maximum number of users.

26. The method according to claim 25, further comprising
comparing the time a user (k) is in the active user subset ({1, . . . , K}) without performing a sounding reference signal (SRS) or demodulation reference signal (DMRS) transmission to a threshold to determine that the maximum time period is exceeded, or limiting the number of users in the active user subset ({1, . . . , K}) to the maximum number of users by first in first out memory of finite or configurable size.

27. The method according to claim 23, further comprising receiving for sub-bands (f in {1, . . . F}) of a plurality of sub-bands ({1, . . . F}), a channel estimate (UL-CSI) for a user (k), and the subset of active users ({1, . . . , K}), and determining per sub-band for the user (k) the recursions
βₖ⁻¹(i)=(1−α)βₖ⁻¹(i−1)+α∥hₖ(i)∥²
R̅ₖ(i)=(1−α)R̅ₖ(i−1)+αhₖ(i)h_{k,[1:P]}^{H}(i)
wherein
i denotes time instance,
k denotes a user,
hₖ(i) denotes a channel vector at the time instance,
R̅ₖ(i) denotes an estimated covariance matrix at the time instance,
α denotes a forgetting factor for the time averaging, in particular 0.01, wherein
βₖ⁻¹(0) and R̅ₖ(0) are initialized with zeros of appropriate size,
[1:P] is a subscript for selecting the first P elements from a vector.

28. The method according to claim 27, further comprising receiving a message, which comprises a user index (k) and a sub-band index of a sub-band of the plurality of sub-bands, configuring or triggering an active user selector to add a particular user (k) to the active user subset ({1, . . . , K}).

29. The method according to claim 27, further comprising determining multiple channel vectors for sub-bands fin {1, . . . F} for a user (k), wherein
$${β}_{k}^{- 1} ( i ) = ( 1 - α ) {β}_{k}^{- 1} ( i - 1 ) + α {\sum }_{f = 1}^{F} {‖ {h}_{k} ( i , f ) ‖}^{2}$$
$${\overline{R}}_{k} ( i ) = ( 1 - α ) {\overline{R}}_{k} ( i - 1 ) + c 1 {\sum }_{f = 1}^{F} {h}_{k} ( i , j ) {h}_{k , [ 1 : P ]}^{H} ( i , f ) .$$

30. The method according to claim 27, further comprising determining a weighted sum over users in the active user subset {1, . . . , K} by
$$\overline{R} ( i ) = {\sum }_{k = 1}^{K} {β}_{k}^{- 1} ( i ) {\overline{R}}_{k} ( i ) .$$

31. The method according to claim 30, further comprising determining the weighted sum over all users in the active user subset ({1, . . . , K}).

32. The method according to claim 27, further comprising determining the weights (W(i)) by a Gram-Schmidt orthonormalization of the estimated covariance matrix.

33. The method according to claim 23, further comprising determining the weights W(i) as
$$W ( i ) = arg {max}_{W ∈ 𝒲} {‖ x ‖}^{2} = {V}_{[ : , 1 : P ]} with$$
$$V {AV}^{H} = {\sum }_{k = 1}^{K} {β}_{k}^{- 1} ( i ) {R}_{k} ( i )$$
wherein
x denotes the received signal, and
βₖ(i)=tr(Rₖ(i)).

34. An apparatus, comprising:
at least one processor; and
at least one memory including computer program code, the at least one memory and the computer program code configured to, with the at least one processor, cause the apparatus at least to:
receive sounding reference signal (SRS) information or demodulation reference signal (DMRS) information, and to determine a channel estimate of a channel for a set of users depending on the information,
receive the sounding reference signal (SRS) information or the demodulation reference signal (DMRS) information, and to determine an active user subset ({1, . . . , K}) of the set of users depending on the information, and
determine weights (W(i)) for long term beamforming depending on the channel estimate and on the active user subset ({1, . . . , K}).

35. The apparatus according to claim 34, wherein the at least one memory and the computer program code are further configured to cause the apparatus to:
determine a channel vector estimate (Hₖ(i)) for a user (k) at a time instance (i) for a sub-band of the channel.

36. The apparatus according to claim 34, wherein the at least one memory and the computer program code are further configured to cause the apparatus to:
determine the subset of active users ({1, . . . , K}) by either comparing a time a user (k) is in the active user subset ({1, . . . , K}) without performing a sounding reference signal (SRS) or demodulation reference signal (DMRS) transmission to a maximum time period, or by limiting a number of users in the active user subset ({1, . . . , K}) to a maximum number of users.

37. The apparatus according to claim 36, wherein the time a user (k) is in the active user subset ({1, . . . , K}) without performing a sounding reference signal (SRS) or demodulation reference signal (DMRS) transmission is compared to a threshold to determine that the maximum time period is exceeded, or wherein the number of users in the active user subset ({1, . . . , K}) is limited to the maximum number of users by first in first out memory of finite or configurable size.

38. The apparatus according to claim 34, wherein the at least one memory and the computer program code are further configured to cause the apparatus to:
receive for a plurality of sub-bands ({1, . . . F}) a channel estimate (UL-CSI) for a user (k), and the subset of active users ({1, . . . , K}), and to determine per sub-band for the user the recursions
βₖ⁻¹(i)=(1−α)βₖ⁻¹(i−1)+α∥hₖ(i)∥²
R̅ₖ(i)=(1−α)R̅ₖ(i−1)+αhₖ(i)h_{k,[1:P]}^{H}(i)
wherein
i denotes time instance,
k denotes a user,
hₖ(i) denotes a channel vector at the time instance,
R̅ₖ(i) denotes an estimated covariance matrix at the time instance,
α denotes a forgetting factor for the time averaging, in particular 0.01, wherein
βₖ⁻¹(0) and R̅ₖ(0) are initialized with zeros of appropriate size,
[1:P] is a subscript for selecting the first P elements from a vector.

39. The apparatus according to claim 38, wherein the at least one memory and the computer program code are further configured to cause the apparatus to:
add a particular user (k) to the active user subset ({1, . . . , K}), depending on a received message, which comprises a user index (k) and a sub-band index of a sub-band of the plurality of sub-bands.

40. The apparatus according to claim 38, the at least one memory and the computer program code are further configured to cause the apparatus to:
determine multiple channel vectors for sub-bands fin {1, . . . F} for a user (k), wherein
$${β}_{k}^{- 1} ( i ) = ( 1 - α ) {β}_{k}^{- 1} ( i - 1 ) + α {\sum }_{f = 1}^{F} {‖ {h}_{k} ( i , f ) ‖}^{2}$$
$${\overline{R}}_{k} ( i ) = ( 1 - α ) {\overline{R}}_{k} ( i - 1 ) + c 1 {\sum }_{f = 1}^{F} {h}_{k} ( i , j ) {h}_{k , [ 1 : P ]}^{H} ( i , f ) .$$

41. The apparatus according to claim 38, wherein the at least one memory and the computer program code are further configured to cause the apparatus to:
determine a weighted sum over users in the active user subset {1, . . . , K} by
$$\overline{R} ( i ) = {\sum }_{k = 1}^{K} {β}_{k}^{- 1} ( i ) {\overline{R}}_{k} ( i ) .$$

42. The apparatus according to claim 41, wherein the weighted sum is determined over all users in the active user subset ({1, . . . , K}).

43. The apparatus according to claim 38, wherein the at least one memory and the computer program code are further configured to cause the apparatus to:
determine the weights (W(i)) by a Gram-Schmidt orthonormalization of the estimated covariance matrix.

44. The apparatus according to claim 34, wherein the weights W(i) are determined as
$$W ( i ) = arg {max}_{W ∈ 𝒲} {‖ x ‖}^{2} = {V}_{[ : , 1 : P ]} with$$
$$V {AV}^{H} = {\sum }_{k = 1}^{K} {β}_{k}^{- 1} ( i ) {R}_{k} ( i )$$
wherein
x denotes the received signal, and
βₖ(i)=tr(Rₖ(i)).
